(19) United States
(12) Patent Application Publication
(10) Pub. No.: US 2004/0078652 A1
(43) Pub. Date: Apr. 22, 2004

(54) Using process quads to enable continuous services in a cluster environment

(76) Inventors: Gunnar D. Tapper, Woodland Park, CO (US); Wendy B. Bartlett, Los Altos, CA (US); Charles S. Johnson, San Jose, CA (US); Gary S. Smith, Auburn, CA (US)

Correspondence Address: Bill Streeter, HEWLETT-PACKARD COMPANY - Intell. Property Admin., P.O. Box 272400, Fort Collins, CO, 80527-2400, US

(21) Appl. No.: 10/095,996

(22) Filed: Mar. 8, 2002

(51) Int. Cl. G06F 11/00

(52) U.S. Cl. 714/13

(57) ABSTRACT

A fault tolerant cluster of computer systems includes a “process quad” comprising four duplicate processes—a primary process and a backup process on a primary system, and a primary process and a backup process on a backup system. The state of the backup process on the primary system is maintained by receiving checkpoint information from the primary process on the primary system, and the states of the primary and backup processes on the backup system are maintained by receiving checkpoint information either directly or indirectly from the primary process on the primary system.

### BACKGROUND OF THE INVENTION

The present invention relates generally to fault-tolerant data processing architectures that use pairs of processes to continue operation in the face of failure of a process or a processor in which a process is running.

Today's computing industry includes the concept of continuous availability, promising a processing environment can be ready for use 24 hours a day, 7 days a week, 365 days a year. This promise is based upon a variety of fault tolerant architectures and techniques, among them being the clustered multiprocessor architectures and paradigms described in U.S. Pat. Nos. 4,817,091 and 5,751,932 to detect and continue in the face of errors or failures, or to quickly halt operation before the error can spread.

The quest for enhanced fault tolerant environments has resulted in the development of the “process pair” technique—described in both of the above identified patents. Briefly, according to this technique, application software (“process”) may run on the multiple processor system (“cluster”) under the operating system as “process-pairs” that include a primary process and a backup process. The primary process runs on one of the processors of the cluster while the backup process runs on a different processor, and together they introduce a level of fault-tolerance into the execution of an application program. Instead of running as a single process, the program runs as two processes, one in each of two different processors of the cluster. If one of the processes or processors fails for any reason, the second process continues execution with little or no noticeable interruption of service. The backup process may be active or passive. If active, it will actively participate in receiving and processing periodic updates to its state in response to checkpoint messages from the corresponding primary process of the pair. If passive, the backup process may do nothing more than receive the updates, and see that they are stored in locations that match the locations used by the primary process. The content of a checkpoint message can take the form of complete state update, or one that communicates only the changes from the previous checkpoint message. Whatever method is used to keep the backup up-to-date with its primary, the result should be the same so that in the event the backup is called upon to take over operation in place of the primary, it can do so from the last checkpoint before the primary failed or was lost.

### SUMMARY OF THE INVENTION

A fault tolerant cluster of computer systems includes a “process quad” comprising four duplicate processes—a primary process and a backup process on a primary system, and a primary process and a backup process on a backup system. The state of the backup process on the primary system is maintained by receiving checkpoint information from the primary process on the primary system, and the states of the primary and backup processes on the backup system are maintained by receiving checkpoint information either directly or indirectly from the primary process on the primary system.

According to one aspect of the invention there is provided a method of operating a cluster of computer systems, each computer system including a plurality of processors, the method comprising:

operating a primary process (PP) and a backup process (BP) on a primary computer system, the primary process (PP) and the backup process (BP) each running on a separate processor;

operating a primary process (PB) and a backup process (BB) on a backup computer system, the primary process (PB) and the backup process (BB) each running on a separate processor;

providing checkpoint information from the primary process (PP) on the primary computer system to the primary process (PB) on the backup computer system.

The method may further comprise the steps of:

providing checkpoint information from the primary process (PP) on the primary computer system to the backup process (BP) on the primary computer system; and

providing checkpoint information from the primary process (PB) on the backup computer system to the backup process (BB) on the backup computer system.

Additionally, the method may further comprise the step of:

responding, by the primary process (PP) on the primary computer system, to an external event only after a response has been received from the primary process (PB) on the backup computer system to the checkpoint information from the primary process (PP) on the primary computer system.

According to a further aspect of the invention, the method may further comprise the steps of:

providing checkpoint information from the primary process (PB) on the backup computer system to the backup process (BB) on the backup computer system; and

responding, by the primary process (PB) on the backup system, to the checkpoint information from the primary process (PP) on the primary computer system only after a response has been received from the backup process (BB) on the backup system to the checkpoint information from the primary process (PB) on the backup system.

According to another aspect of the invention there is provided a cluster of computer systems, comprising:

a primary computer system including a primary process (PP) and a backup process (BP), the primary process (PP) and the backup process (BP) each running on a separate processor;

a backup computer system including a primary process (PB) and a backup process (BB), the primary process (PB) and the backup process (BB) each running on a separate processor; and

a network between the primary computer system and the backup computer system for conveying checkpoint information from the primary process (PP) on the primary computer system to the primary processes (PB) on the backup computer system.

The primary process (PP) on the primary computer system may be configured to:

provide checkpoint information to the backup process (BP) on the primary computer system; and

the primary process (PB) on the backup computer system may be configured to:

provide checkpoint information to the backup process (BB) on the backup computer system.

Further, the primary process (PP) on the primary computer system may be configured to:

respond to an external event only after a response has been received from the primary process (PB) on the backup computer system to the checkpoint information from the primary process (PP) on the primary computer system.

Still further, the primary process (PB) on the backup computer system may be configured to:

provide checkpoint information to the backup process (BB) on the backup computer system; and

the primary process (PB) on the backup system may be configured to:

respond to the checkpoint information received from the primary process (PP) on the primary computer system only after a response has been received from the backup process (BB) on the backup system to the checkpoint information from the primary process (PB) on the backup system.

Further aspects of the invention will be apparent from the Detailed Description of the Drawings.

### BRIEF DESCRIPTION OF THE DRAWINGS

The accompanying drawings, which are incorporated in and constitute a part of this specification, illustrate several embodiments of the invention and together with the description, serve to explain the principles of the invention. Wherever convenient, the same reference numbers will be used throughout the drawings to refer to the same or like elements.

FIG. 1 is a schematic diagram showing a System Area Network embodying the invention;

FIG. 2 is a schematic diagram showing process quads embodied in two multi-processor systems of the System Area Network of FIG. 1;

FIG. 3 is a timing diagram showing the passing of checkpoint information and responses in the process quads of FIG. 2; and

FIG. 4 is a schematic diagram showing the two systems of FIG. 2 including local and global synchronization tables.

### DETAILED DESCRIPTION OF THE INVENTION

To enable one of ordinary skill in the art to make and use the invention, the description of the invention is presented herein in the context of a patent application and its requirements. Although the invention will be described in accordance with the shown embodiments, one of ordinary skill in the art will readily recognize that there could be variations to the embodiments and those variations would be within the scope and spirit of the invention.

To provide the level of fault tolerance of the invention, some type of high-speed interprocessor communication system is required. In one embodiment of the invention, the high speed interprocessor communication is provided by means of a System Area Network (SAN). One example of a System Area Network (SAN) is that proposed by the Infiniband™ (IB) Trade Association. The IB SAN is used for connecting multiple, independent processor platforms (i.e., host-processor nodes), input/output (I/O) platforms, and I/O devices. The IB SAN supports both I/O and interprocessor communications for one or more computer systems. An IB system can range from a small server with one processor and a few I/O devices, to a parallel installation with hundreds of processors and thousands of I/O devices. Furthermore, the IB SAN allows bridging to an internet, intranet, or connection to remote computer systems. IB provides a switched communications fabric allowing many devices to concurrently communicate with high bandwidth and low latency. An end node can communicate over multiple IB ports and can utilize multiple paths through the IB fabric. The multiplicity of IBA ports and paths through the network are exploited for both fault tolerance and increased data-transfer bandwidth. IB hardware off-loads from the instruction-processing unit much of overhead associated with the I/O communications operation.

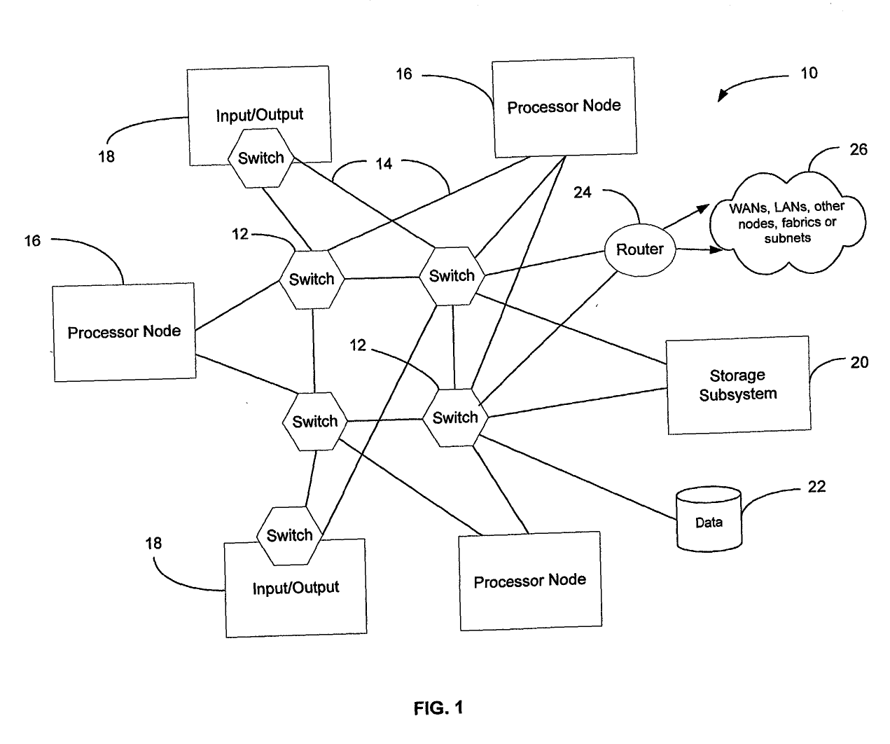

Referring now to the figures, and in particular FIG. 1, shown is a System Area Network (SAN) 10 incorporating the invention. The SAN 10 comprises a switch fabric and a number of nodes interconnected by the switch fabric. The switch fabric is generally accepted to be the switches 12 and the interconnecting links 14, while the nodes can, for example, include processor nodes 16, I/O nodes 18, storage subsystems 20 (e.g., a redundant array of independent disk (RAID) system) or a storage device such as a hard drive 22. The switch fabric may also include routers 24 to provide a link to other wide- or local-area networks, other nodes, fabrics, or subnets 26. When the SAN 10 forms part of a number of interconnected SANs, it is typically referred to as a subnet. The SAN nodes may attach to a single or multiple switches 12 and/or directly to one another. Well known examples of SANs include that proposed by the Infiniband™ (IB) Trade Association as mentioned above, as well as the ServerNet™ processor and I/O interconnect by Compaq Computer Corporation. It should be noted however that, while the invention is described herein with reference to a SAN architecture, any appropriate means of providing interprocessor communications may be used in the invention, for example, a dedicated high-speed interprocessor bus may be used.

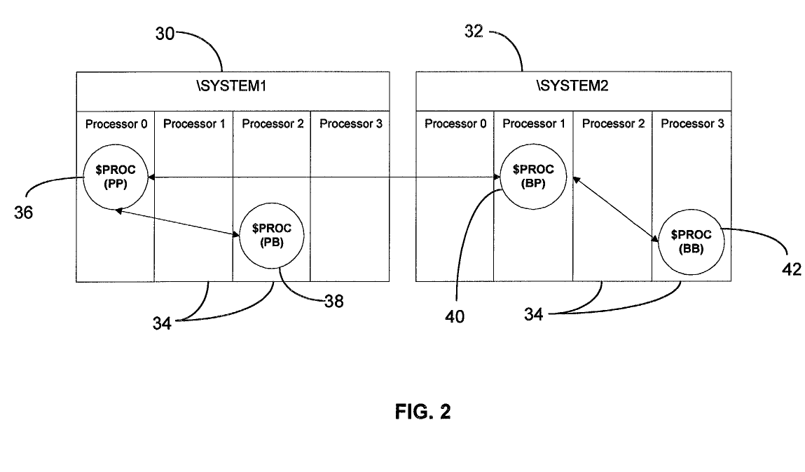

FIG. 2 shows a primary system 30 and a backup system 32. The systems 30, 32 each correspond to a processor node 16 in FIG. 1, and each comprise of a plurality of processors (instruction-processing units) 34. The primary system 32 has a primary process 36 running on processor 0 and a backup process 38 running on processor 2, while the backup system 32 has a corresponding primary process 40 running on processor 1 and a backup process 42 running on processor 3. For the sake of convenience, we shall refer to these four processes as follows:

PP 36—Primary system, primary process;

PB 38—Primary system, backup process;

BP 40—Backup system, primary process; and

BB 42—Backup system, backup process.

Note however that primary system 30 and backup system 32 have only been designated as such with reference to the illustrated processes, and for ease of understanding. Primary system 30 and backup system 32 may have their roles reversed, or be completely unrelated, with reference to other processes running thereon.

Upon startup, process PP 36 creates PB 38 and BP 40, and BP 40 creates BB 42.

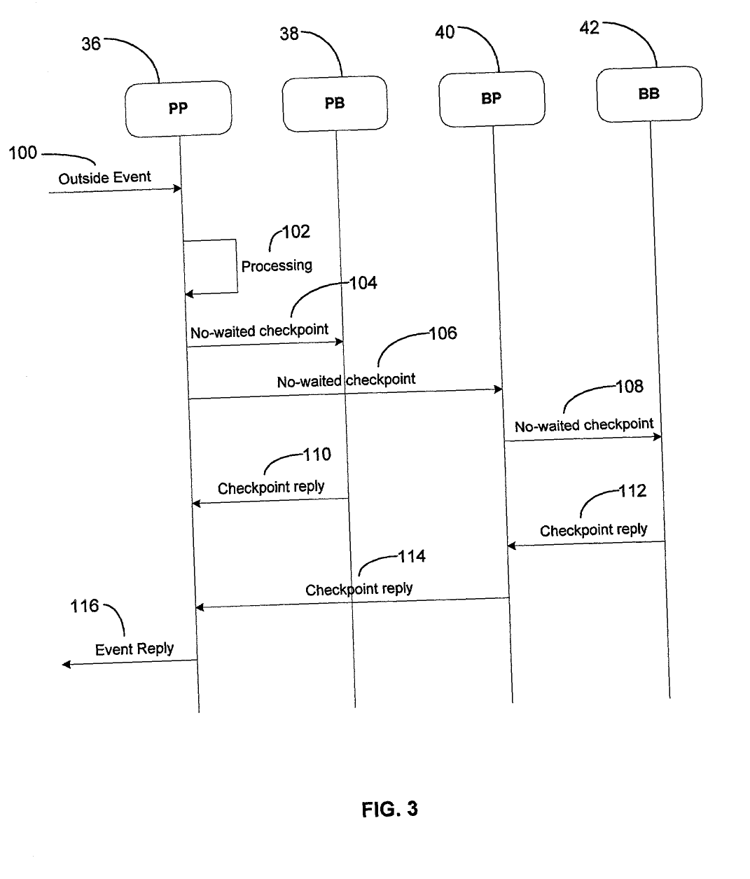

The processes PB 38, BP 40, and BB 42 are duplicates of the primary process PP 36, and are intended to provide fault-tolerant processing. This fault-tolerant processing is provided by means of redundancy, that is, if primary process PP 36 should fail, if processor 0 should fail, or if the primary system 30 should fail, one of the other processes is available to continue the work being performed by the primary process PP 36. In order to keep processes PB 38, BP 40, and BB 42 up-to-date with primary process PP 36 as its processing continues, it is necessary to provide checkpoint information to processes PB 38, BP 40, and BB 42. This is conducted as follows, referring to FIG. 3.

PP 36 receives 100 a message from an outside source, and conducts some processing 102 to handle this message. At some point, PP 36 must checkpoint the results and changes caused by this processing. Therefore, PP 36 writes 104 a no-waited checkpoint message to the backup process on the primary system; that is, PB 38. In addition, PP 36 writes 106 a no-waited checkpoint message to the primary process on the backup system; that is, BP 40. After this, PP 36 waits for checkpoint acknowledgements before replying to the outside event.

To ensure that BB 42 remains up to date, BP 40 writes 108 a no-waited checkpoint message to BB 42. After this, BP 40 waits for BB 42 to acknowledge the checkpoint message.

In due course, PB 38 acknowledges 110 the checkpoint message from PP 36. At this point, PP 36 waits for the acknowledgement from BP 40 before a reply to the outside event can be given. Note that the acknowledgements from PB 38 and BP 40 can arrive in either order.

In due course, BB 42 acknowledges 112 the checkpoint message from BP 40. Once BP 40 has received the acknowledgement from BB 42, it can acknowledge 114 the checkpoint message from PP 36.

Once PP 36 has received acknowledgements from both PB 338 and BP 40, it can respond 116 to the outside message.

The nature and content of the checkpoint messages are conventional, with the exception that additional checkpoint messages are provided to BP 40 and BB 42 as described above. Accordingly, existing dual-processing schemes are readily adapted to the quad architecture and methods described herein.

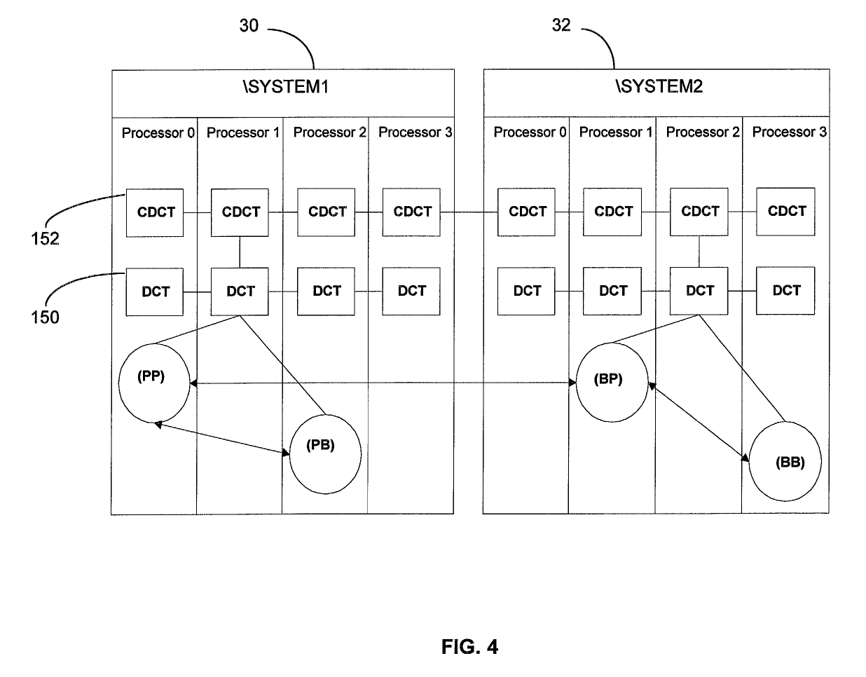

To provide transparent takeover processing in the case of failure of one or more of the primary or backup processes, a system of tables is provided to permit addressing of the process by logical name and not by means of the resource on which the process is running. By addressing the process by name, a resource using or responding to the process need not concern itself with keeping track of which of the primary or backup processes is actually functioning as the primary process, or where the process is actually being hosted. The relationship between the logical name of the process and the location of the primary process PP is maintained by means of a local Destination Control Tables (DCT) 150 and global Cluster Destination Control Tables (CDCT) 152, as shown in FIG. 4.

The DCTs 150 of each system 30, 32 maintain information named entities, including process pairs running in that system. The lines between the DCT 150 for each processor on one system illustrate the fact that, within a particular system, the DCTs are synchronized; that is, any change made to a DCT 150 in a system is reflected to the other DCTs in the same system. The DCT 150 is provided by the file system/messaging system of each system 30, 32, and the file/messaging sub-system routes requests to the appropriate process based on information contained in the DCT 150. Conceptually, a DCT 150 contains at a minimum the information that “The process named X is running on Processor Y with Process ID Z.”

A similar service is provided at the global or SAN level by the CDCT 152. CDCTs 152 exist in every processor for every system that participates in the SAN, and the lines between the CDCTs 152 indicate that the CDCTs 152 are synchronized across the entire SAN; that is, a change in one CDCT 152 is replicated to all other CDCTs. Synchronization of the CDCTs 152 will typically take place in two steps. First, the CDCTs 152 on a particular system will be updated (i.e., a local update), after which a message will be sent from the particular system to the other systems indicating that an update is to be performed on their CDCTs (i.e., a global update). Conceptually, a CDCT 152 contains at a minimum information that “The process named X is running on System Z.”

The implementation of global updates in multiprocessor systems is well known and will not be discussed in further detail here. For further reference, see for example U.S. Pat. No. 4,718,002 to Richard W. Carr, entitled “Method for Multiprocessor Communications,” the disclosure of which is incorporated herein by reference as if explicitly set forth.

In an alternative embodiment, the consistency of the CDCTs is maintained by using the well-known “Thomas Write Rule” disclosed originally in A Majority consensus approach to concurrency control for multiple copy databases, Robert H. Thomas, Volume 4, Issue 2 (June 1979) ACM Transaction on Database Systems (TODS)), the disclosure of which is incorporated herein by reference as if explicitly set forth. This method is based on a quorum consensus of the systems in the network. That is, an update request that is made by a particular CDCT is communicated amongst the CDCTs, which then vote on the acceptability of the update request. For a request to be accepted and applied to all CDCTs, only a majority of the CDCTs need approve the update request. Once an update request is approved by a majority of the CDCT's, it is applied to all CDCTs. Timestamps are also used in voting to determine the currency of update request base variables, and are used in the actual update to guarantee that recent updates supersede older ones. The Thomas Write Rule provides deadlock free operation, and preserves both internal consistency and mutual consistency of the CDCTs. Also, central control of CDCT updates is not required using this update method. The Thomas Write Rule and its application is well known, and its implementation details are within the abilities of one of ordinary skill in the art, and it will thus not be described further here.

As a further alternative, instead of CDCTs, the correlation among processes and the systems on which they are running can be maintained at on one or more name servers analogous to Internet DNS (domain name system) servers. In such a case, presented with the name or a process, the name server would return the location of the process. Updates to the name servers would be handled conventionally as for DNS servers.

The relationship between the various processes in a process quad is maintained by the process quad itself, and not by the DCTs or the CDCTs. That is, the process quad itself is the final authority on which process is a primary process and which is a backup process, and which system is the primary system and which is the backup system. Also, the checkpointing messages and replies thereto are directed by the sender process directly to the processor running the recipient process, which is an exception to the rule that processes are addressed by name and not by resource identifier.

Although configured to ensure that messages are routed correctly, it is possible that an incoming message from an external caller may be routed to the wrong system. Should this happen, the primary process on the backup system (i.e., BP 40) will reject the message and provide the caller with information as to which system the message should be sent instead. The message will then be resent by the caller to the system name provided in the error message sent by BP 40.

The fact that a message for PP 36 arrived at the wrong system BP 40 is indicative of a fault in the CDCTs 152, since it is the CDCTs that maintain the relationship between the process names and the system on which they are running. Accordingly, it is now necessary to update the CDCTs 152 to remove the error. The update of the CDCTs 152 is first conducted locally in the system BP 40 that received the misrouted message, and an update message is then sent to all the systems participating in the SAN. At each system receiving the update message, the receiving system checks to see whether the information in its CDCTs 152 needs to be updated, and, if so, performs a local update of the CDCT 152.

When there is a need for one or another of the backups to assume the role of the PP36, for example, upon failure of the system 30 or processor 0, the takeover is handled differently depending on the whether or not PB38 is available to assume the role of PP36. Takeovers between the members of a pair within a system is usually automated. That is, a backup process within a system should elevate itself to primaryhood automatically if its other half disappears. In the case where a process on another system is required to become the primary process (e.g. upon failure of system 30), some type of supervisory agent, upon being alerted of the failure, will review the situation and designate the appropriate backup (typically BP 40) to continue operating as the new primary process. Often, the supervisory agent will be a human operator. Alternatively, a supervisory program could be created with a set of rules defining how the takeover is to proceed under alternative situations.

Upon takeover, transactions that were in process are either rolled back or repeated as necessary, as is known in the dual-process art, to ensure that processing continues without interruption. Also, upon takeover, the new primary process can create new backup processes to restore the process quad.

The switch-over to a backup system typically creates more of an impact (in terms of delayed transactions, for example) than an intra-system takeover. Furthermore, a system-level takeover often means manual operations to switch lines (connecting customers, for example) from one system to another, and may involve delays or other undesirable effects. This is why BP 40 is typically selected to continue operating as the new primary process in the event of failure of the existing primary process PP30.

The process quad architecture and methods described above are preferable to a process pair that spans two systems, as a single processor failure would force a switch-over to the backup system. This would result in the loss of availability of both the process and a first backup on a single system, reducing overall availability characteristics.

Also, a process quad is preferable to a process “triplet” (i.e., a process pair on one system and a single backup process on a backup system) because, during failure of a process, there would be a vulnerability to further failure. This vulnerability would open at the start of the takeover by one of the backup processes, and only close when a replacement backup was created. Also, any recreation of the process on the backup system would require checkpointing of all of the process' data between the systems, thereby creating a potential problem as regards system performance.

With a process quad, these problems are reduced. Firstly, a single process failure on either of the systems, or a processor failure on one of the systems, still leaves another process alive on that system, reducing the window of vulnerability. Secondly, the return to a full fault-tolerant state will be require reduced checkpointing, since the failed process can be recreated from the remaining process that is still alive on the same system. Of course, if a system should fail, recreating the process quads would require checkpointing between the surviving system and the new backup system.

For the purposes of the discussion above, it has been assumed that the SAN 10 is a theoretical “perfect” network. This type of network will have redundant paths and will never have failures of portions of the network that cause the network to partition. A partition occurs when a portion of a network fails, with part of the network still being available. In such a case, some systems are typically able to communicate with each other, while others cannot. Partitions are generally classified by the duration of the partition, with a short partition being a “glitch” with a true partition typically lasting longer. It is useful to assume a “perfect” network as the basis for describing the methods used to control the state of the process quad and the up or down state of the connected servers. In such a perfect network, it is assumed that the communication routes (i.e. links 14 and switches 12) are reliable, and that the only failures that occur are of the systems 30, 32, the processors 0, 1, 2, or 3, or of the processes 36, 38, 40 or 42.

In the real world, SANs are imperfect. That is, while these systems have redundant paths, they can nevertheless partition or glitch. Imperfect SANs are addressed by using external paths to back up the redundant SAN connections. Here, multiple external paths using the Internet Protocol, standard routers, and connections to the outside world are used in case the SAN connection fails. This would require that there are no common points of failures between the SAN and its backup; that is, the SAN and the SAN backup cannot share, for example, trenches, cable runs, or power and facility support. Hence, it is necessary to separate completely the modes of network attachment for the systems on which the process quad runs: communication, routing, hardware, software, protocol, and stack are all different —four-fold (or more) failures of different modes would be require before the network failed.

Although the present invention has been described in accordance with the embodiments shown, variations to the embodiments would be apparent to those skilled in the art and those variations would be within the scope and spirit of the present invention. Accordingly, it is intended that the specification and embodiments shown be considered as exemplary only.

What is claimed is:

1. A method of operating a cluster of computer systems, each computer system including a plurality of processors, the method comprising:
operating a primary process (PP) and a backup process (BP) on a primary computer system, the primary process (PP) and the backup process (BP) each running on a separate processor;
operating a primary process (PB) and a backup process (BB) on a backup computer system, the primary process (PB) and the backup process (BB) each running on a separate processor;
providing checkpoint information from the primary process (PP) on the primary computer system to the primary process (PB) on the backup computer system.

2. The method of claim 1 further comprising the step of:
providing checkpoint information from the primary process (PP) on the primary computer system to the backup process (BP) on the primary computer system.

3. The method of claim 2 further comprising the step of:
providing checkpoint information from the primary process (PB) on tile backup computer system to the backup process (BB) on the backup computer system.

4. The method of claim 1 further comprising the step of:
responding, by the primary process (PP) on the primary computer system, to an external event only after a response has been received from the primary process (PB) on the backup computer system to the checkpoint information from the primary process (PP) on the primary computer system.

5. The method of claim 4 further comprising the step of:
providing checkpoint information from the primary process (PB) on the backup computer system to the backup process (BB) on the backup computer system.

6. The method of claim 5 further comprising the step of:
responding, by the primary process (PB) on the backup system, to the checkpoint information from the primary process (PP) on the primary computer system only after a response has been received from the backup process (BB) on the backup system to the checkpoint information from the primary process (PB) on the backup system.

7. The method of claim 6 further comprising the step of:
providing checkpoint information from the primary process (PP) on the primary computer system to the backup process (BP) on the primary computer system.

8. A cluster of computer systems, comprising:
a primary computer system including a primary process (PP) and a backup process (BP), the primary process (PP) and the backup process (BP) each running on a separate processor;
a backup computer system including a primary process (PB) and a backup process (BB), the primary process (PB) and the backup process (BB) each running on a separate processor; and
a network between the primary computer system and the backup computer system for conveying checkpoint information from the primary process (PP) on the primary computer system to the primary process (PB) on the backup computer system.

9. The cluster of claim 8 wherein the primary process (PP) on the primary computer system is configured to
provide checkpoint information to the backup process (BP) on the primary computer system.

10. The cluster of claim 9 wherein the primary process (PB) on the backup computer system is configured to:
provide checkpoint information to the backup process (BB) on the backup computer system.

11. The cluster of claim 8 wherein the primary process (PP) on the primary computer system is configured to:
respond to an external event only after a response has been received from the primary process (PB) on the backup computer system to the checkpoint information from the primary process (PP) on the primary computer system.

12. The cluster of claim 11 wherein the primary process (PB) on the backup computer system is configured to:
provide checkpoint information to the backup process (BB) on the backup computer system.

13. The cluster of claim 12 wherein the primary process (PB) on the backup system is configured to:
respond to the checkpoint information received from the primary process (PP) on the primary computer system only after a response has been received from the backup process (BB) on the backup system to the checkpoint information from the primary process (PB) on the backup system.

14. The cluster of claim 13 wherein the primary process (PP) on the primary computer system is configured to:
provide checkpoint information to the backup process (BP) on the primary computer system.
